(19) United States
(12) Patent Application Publication
(10) Pub. No.: US 2019/0026779 A1
(43) Pub. Date: Jan. 24, 2019

(54) METHOD AND SYSTEM FOR DYNAMIC VEHICLE-MOUNTED DISPLAY

(71) Applicant: Dominick DeLucia, Pittsford, NY (US)

(72) Inventor: Dominick DeLucia, Pittsford, NY (US)

(21) Appl. No.: 15/653,072

(22) Filed: Jul. 18, 2017

(51) Int. Cl. G06Q 30/02; G09G 5/00

(52) U.S. Cl. CPC G06Q 30/0265; G09G 5/003; G06Q 30/0275; G09G 2380/10; G09G 2354/00; G09G 2370/16; G06Q 30/0277

(57) ABSTRACT

A method for displaying information on a vehicle-mounted device, the method including the steps of: (i) receiving display input from an advertiser, the display input comprising information to be displayed on the vehicle-mounted device and one or more display parameters; (ii) sending the received display input to a user device of the vehicle-mounted device display system; (ii) approving the received display input for display on the vehicle-mounted device; (iv) sending the approved display input from the user device to the vehicle-mounted device for display; and (v) displaying the approved display input on the vehicle-mounted device.

### FIELD OF THE INVENTION

The present disclosure is directed generally to methods and systems for dynamically displaying information using an electronic vehicle-mounted device.

### BACKGROUND

Advertising is a multi-billion dollar industry in the United States as well as the rest of the world. Advertising takes many different formats as advertisers try to reach their target audience. Accordingly, advertisers will consider such factors as potential audience that will view the advertisement, the location(s) covered by the advertisement, the timing of the advertisement, and many, many other factors.

One form of advertising is mobile advertising, in which a billboard or digital display with advertising is affixed to or on a moving object. Advertisers, recognizing the large impact that a mobile advertisement can have and after considering the area(s) through with the mobile advertisement will travel, often chose mobile advertising as a means to advertise their goods and/or services.

The most common forms of mobile advertising are mobile billboards and rooftop-mounted displays. Mobile billboards can be either the sides of trucks or buses, or can be a vehicle entirely dedicated to driving around a city or other highly populated area with a large billboard on the back of the vehicle. Although these mobile billboards provide considerable advertising real estate, they are expensive and thus are not changed often.

Rooftop-mounted displays can be analog or digital. Some analog displays comprise a single, fixed object, poster, or other display, while others comprise a small handful of rotating displays that typically rotate in a fixed manner based on a timer. Digital displays are more adaptable and can be modified by the advertiser or the owner of the taxi.

However, all these means of mobile advertising are largely fixed without manual manipulation, and do not account for other desirable factors such as time of day, location, proximity to the advertising entity, and other similar factors. For example, these existing methods of mobile advertising do not, for example, automatically account for—or react to—the location of the display. Similarly, the existing methods of mobile advertising do not account for—or react to—the time of day during which an advertisement is being displayed.

Accordingly, there is a continued need in the art for methods and systems of dynamically displaying information using an electronic vehicle-mounted device.

### SUMMARY OF THE INVENTION

The present disclosure is directed to inventive methods and systems for dynamically displaying information using an electronic vehicle-mounted device. Various embodiments and implementations herein are directed to a networked system comprising an electronic rooftop-mounted device, a computing device, and a remote portal. The networked system receives information to be dynamically displayed on the electronic vehicle-mounted device from the remote portal and/or from the computing device, which can be a smartphone, laptop, wearable device, or other computing device such as one utilized by the driver or a passenger of the vehicle. The electronic vehicle-mounted device is in communication with, and optionally at least partially controlled by, the remote portal and/or from the computing device. The electronic vehicle-mounted device displays information dynamically using one or more of a variety of factors, including but not limited to location, time, date, and many other factors.

Generally, in one aspect, a method for displaying information on a vehicle-mounted device is provided. The method includes the steps of: (i) receiving display input from an advertiser, the display input comprising information to be displayed on the vehicle-mounted device and one or more display parameters; (ii) sending the received display input to a user device of the vehicle-mounted device display system; (iii) approving the received display input for display on the vehicle-mounted device; (iv) sending the approved display input from the user device to the vehicle-mounted device for display; and (v) displaying the approved display input on the vehicle-mounted device.

According to an embodiment, the display input comprises one or more parameters for the display of the display input on the vehicle-mounted device.

According to an embodiment, the method further includes the step of modifying, based on at least one of the one or more parameters, the display of the approved display input on the vehicle-mounted device. According to an embodiment, the one or more parameters comprises at least one of a geographical parameter and a scheduling parameter.

According to an embodiment, the display input further comprises a bid for display of the display input on the vehicle-mounted device, and wherein the method further comprises the step of determining a winning bid for display of the display input on the vehicle-mounted device, wherein the received display input associated with the winning bid is sent to the user device.

According to an embodiment, the user device is a smartphone, wearable computing device, or other computing device.

According to an aspect is a method for displaying information on a vehicle-mounted device. The method includes the steps of: (i) receiving display input from a plurality of advertisers, each received display input comprising information to be displayed on the vehicle-mounted device and one or more parameters for the display of the display input on the vehicle-mounted device, and further comprising a bid for display of the display input on the vehicle-mounted device; (ii) determining, by the vehicle-mounted device display system, a winning bid among the plurality of received bids; (iii) sending the received display input associated with the winning bid to a user device of the vehicle-mounted device display system; (iv) approving the received display input for display on the vehicle-mounted device; (v) sending the approved display input from the user device to the vehicle-mounted device for display; (vi) displaying the approved display input on the vehicle-mounted device; and (vii) modifying, based on at least one of the one or more parameters, the display of the approved display input on the vehicle-mounted device.

According to an embodiment, the method further includes the step of determining, by the vehicle-mounted device display system or user device, a location of the vehicle-mounted device; wherein the display of the approved display input on the vehicle-mounted device is modified based on the determined location.

According to an embodiment, the one or more parameters comprises a geofence.

According to an embodiment, a user of the user device approves the received display input for display on the vehicle-mounted device.

According to an aspect is a system for displaying information on a vehicle-mounted device. The system includes: (i) a vehicle-mounted device comprising a display configured to display approved advertiser display input; (ii) an advertiser portal configured to receive display input from an advertiser, the display input comprising information to be displayed on the vehicle-mounted device and one or more display parameters; (iii) a display controller configured to receive, from the advertiser portal, the advertiser display input; and (iv) a user device configured to receive the advertiser display input from the display controller, and further configured to send approved advertiser display input to the vehicle-mounted device.

According to an embodiment, the advertiser portal is a website or a mobile application in communication with a server.

According to an embodiment, the display input further comprises one or more parameters for the display of the display input on the vehicle-mounted device. According to an embodiment, the user device is further configured to modify, based on at least one of the one or more parameters, the display of the approved advertiser display input on the vehicle-mounted device.

According to an embodiment, the display input further comprises a bid for display of the display input on the vehicle-mounted device; and the display controller is further configured to determine a winning bid for display of the display input on the vehicle-mounted device.

According to an embodiment, the user device is configured to: (i) determine a location of the vehicle-mounted device; and (ii) modify, based on the determined location, the display of the approved advertiser display input on the vehicle-mounted device.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a rooftop-mounted device system, in accordance with an embodiment.

FIG. 2 is a schematic representation of a vehicle-mounted device system, in accordance with an embodiment.

FIG. 3 is a schematic representation of a vehicle-mounted device system, in accordance with an embodiment.

FIG. 4 is a schematic representation of a system for dynamically displaying information on a vehicle-mounted device, in accordance with an embodiment.

FIG. 5 is a flowchart of a method for dynamically displaying information on a vehicle-mounted device, in accordance with an embodiment.

### DETAILED DESCRIPTION OF EMBODIMENTS

The present disclosure describes various embodiments of a networked system configured to dynamically display information on a vehicle-mounted device, comprising an electronic vehicle-mounted device, a computing device, and a remote portal. The system utilizes information provided via the computing device or remote portal, such as an online portal, for dynamic display. The received information includes user-defined data utilized to create one or more parameters for the dynamic display of information on a networked device. The parameters can include, among many other parameters, location-based, time-based, and/or date-based display of information, among many other parameters.

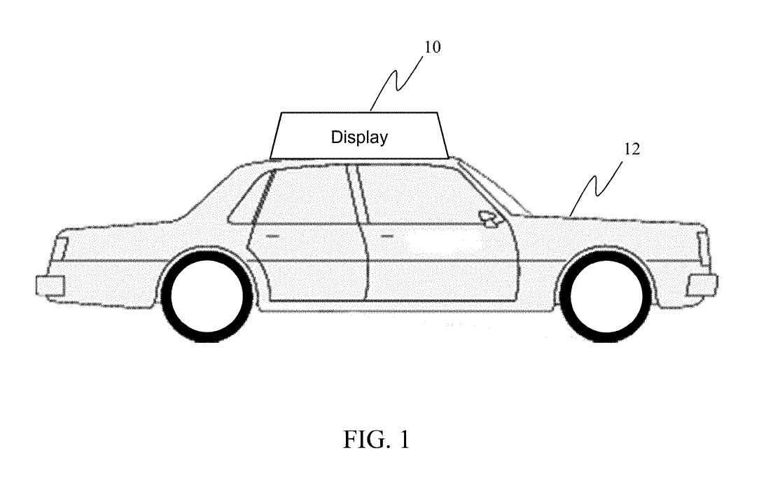

Referring to FIG. 1, in one embodiment, is a vehicle 12 comprising an electronic vehicle-mounted device 10. Vehicle 12 is any vehicle, including but not limited to a car, taxi, minivan, truck, tractor-trailer, carriage, and/or any other type of vehicle. Vehicle-mounted device 10 is any display device configured to and capable of displaying information that can be perceived by one or more observers. For example, electronic vehicle-mounted device 10 can comprise one or more displays or screens configured to display information digitally. Alternatively, electronic vehicle-mounted device 10 can comprise one or more displays or screens configured to display analog information, such as switching between two or more fixed displays. According to an embodiment, the electronic vehicle-mounted device 10 comprises a power source (not shown) such as a wired connection to vehicle 12, battery power, and/or solar or wind power. The vehicle-mounted device can be permanently or temporarily mounted to vehicle 12, using any means or method of connection.

For example, according to an embodiment, the vehicle-mounted device 10 is a two-sided, waterproof and weatherproof display screen box with wireless connectivity, and is mounted on the vehicle using magnetic or suction capabilities, among other methods. It can come in a wide variety of shapes and sizes, including but not limited to square, rectangular, and triangular.

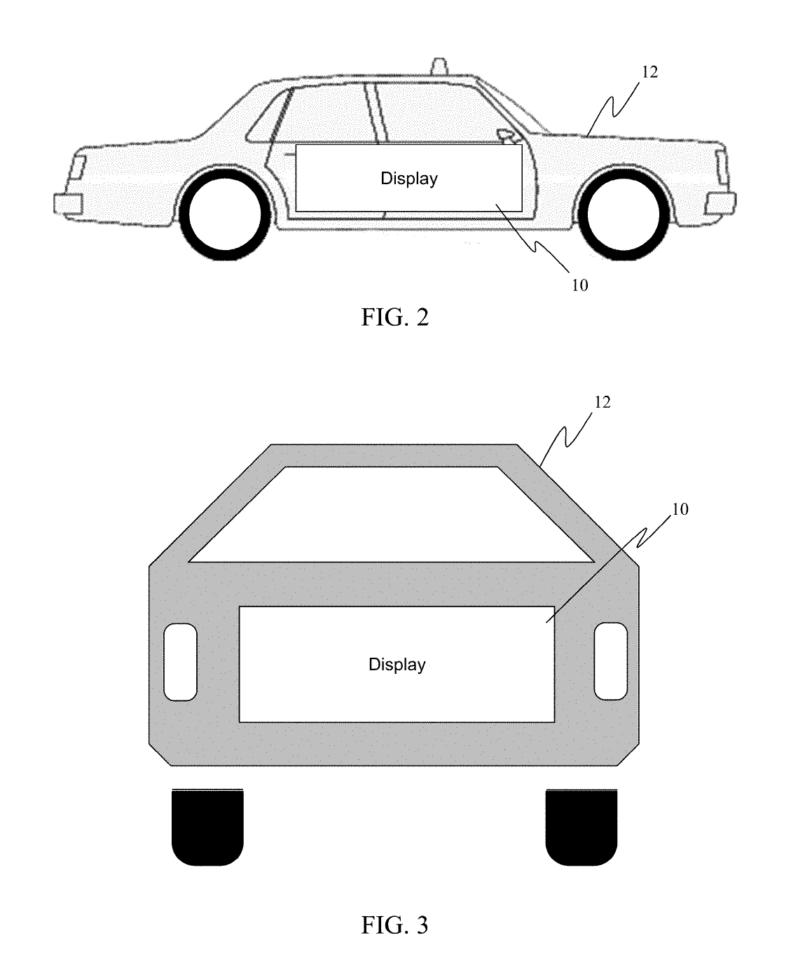

Referring to FIG. 2, in one embodiment, is a vehicle 12 comprising an electronic vehicle-mounted device 10. Electronic vehicle-mounted device 10 is mounted on a side panel of vehicle 12. Similarly, referring to FIG. 3, in one embodiment, electronic vehicle-mounted device 10 is mounted on a rear panel of vehicle 12. The electronic vehicle-mounted device may be mounted anywhere on and/or within the vehicle 12.

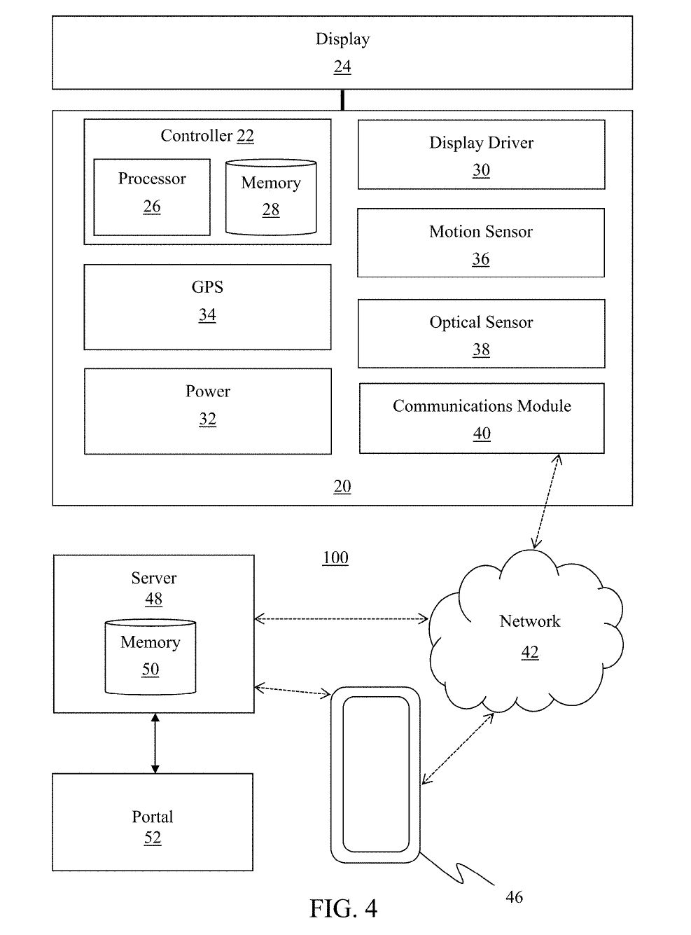

Referring to FIG. 4, in one embodiment, is a system 100 configured to dynamically display information on a vehicle-mounted device. According to an embodiment, the system comprises a controller device 20 comprising a controller 22. Controller 22 is configured to control or program a display 24 in response to input or instructions as described herein. Controller 22 can comprise, for example, a processor 26 and a memory 28. Processor 26 can be any suitable processor, such as a microprocessor, and can be one or multiple processors. Memory 28 can be any non-transitory storage device or system, and can store an operating system or other software or instructions configured to execute one or more functions of the methods described or otherwise envisioned here.

According to an embodiment, system 100 comprises a display driver 30 configured to controller operation of the display 24, such as in response to input or directions from controller 22. The display driver is configured to cause dynamic display of information on the vehicle-mounted device 10. Display 24 can be, for example, a display of the vehicle-mounted device 10, and can be any display configured to and capable of displaying information that can be perceived by one or more observers.

According to an embodiment, system 100 comprises a power source 32, which can be any power source suitable to provide power to the controller device 20. For example, the power source can be from the vehicle directly, and/or can be battery power, solar power, or wind power.

According to an embodiment, system 100 comprises a location-aware or location-determination module 34, such as a global positioning system (GPS) receiver. Location-aware module 34 can determine an exact or approximate location and can provide that information to the controller 22 and/or to a user or other remote entity, server, or computer via a communications module. For example, location-aware module 34 can be a GPS receiver that continuously or periodically receives signals utilized to determine a location, and can continuously or periodically provide that information to a user interface and/or to the controller 22. This allows the system to be location-aware, which can factor into the display as described or otherwise envisioned herein.

According to an embodiment, system 100 comprises a motion sensor 36, which may be separate from or integral to controller 22. The sensor can be any motion sensor such as an accelerometer or gyroscope, and can determine whether the device is in motion, as well as describe one or more parameters of that motion. For example, motion sensor 36 can be an accelerometer that continuously or periodically produces sensor data and can continuously or periodically provide that information to a user interface and/or to the controller 22. This allows the system to know when it is in motion, and to describe one or more parameters of that motion.

According to an embodiment, system 100 comprises an optical sensor 38. The optical sensor can be a light sensor configured to determine an ambient lighting level of the environment and thus determine an approximate time of day. According to another embodiment, optical sensor 38 is a camera configured to obtain one or more images of the device's environment. This information could be utilized, for example, to determine approximate location by comparing obtained images to a library of images, and/or to determine an approximate time of day based on shadow lengths and/or ambient light levels, among many other uses of the optical sensor.

According to an embodiment, system 100 comprises a communications module 40 configured and/or programmed to receive and/or transmit data from or to a wireless transceiver. For example, communications module 40 may transmit sensor data from one or more of the location-aware module 34, motion sensor 36, and optical sensor 38. Communications module 40 can also transmit information to and/or from controller 22. Communications module 40 can communicate via a wired and/or wireless communications link.

System 100 may comprise a communications network 42 configured to enable communications between the communications module 40 of the controller device 20 and one or more external devices. The communications network 42 may be, for example, an internet, intranet, LAN, or any other network. Communication over that network may be wired and/or wireless, and may comprise a Wi-Fi connection, a Bluetooth connection, or any other wired or wireless connection.

System 100 may also comprise a user device 46, such as a desktop, laptop, smartphone, tablet, wearable, or any other computing device. For example user device 46 is a smartphone utilized by a driver or passenger of the vehicle. According to an embodiment, device 46 communicates with the controller device 20 via a wired and/or wireless network such as network 42. Communication over that network may be wired and/or wireless, and may comprise a Wi-Fi connection, a Bluetooth connection, or any other wired or wireless connection. According to an embodiment, user device 46 is utilized as in input and/or output device for one or more components of system 100, including but not limited to controller device 20. For example, user device 46 may be utilized to provide or receive information, authorization, and/or any other information or control to or from controller device 20.

According to an embodiment, system 100 comprises a remote server 48 configured to communicate with the controller device 20 and/or user device 46. The remote server can communicate with the controller device 20 and/or user device 46 via any wired and/or wireless communications link, including but not limited to network 42. The remote serve can comprise a memory 50 which is configured to store data and/or to store software configured to execute or facilitate one or more functions of the systems and methods described herein.

According to an embodiment, server 48 comprises, controls, creates, or is in communication with a portal 52, which is configured to obtain and/or provide information to a remote user. Portal 52 can be an internet or intranet portal configured to receive information from, and provide information to, the remote user as described or otherwise envisioned herein.

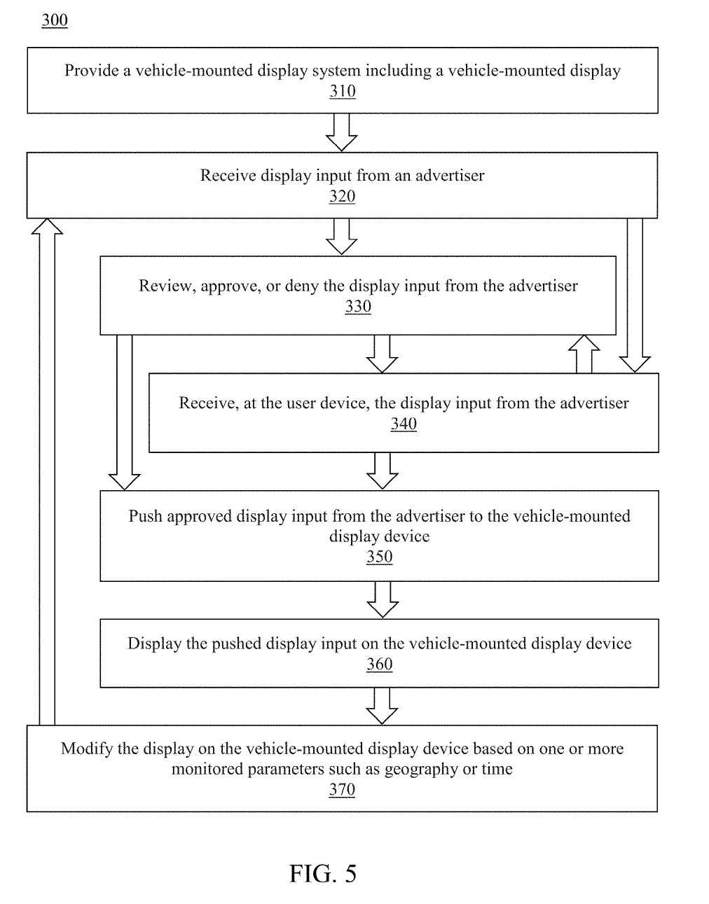

Referring to FIG. 5, in one embodiment, is a flowchart of a method 300 for displaying information on a vehicle-mounted device. At step 310 of the method, a system for a vehicle-mounted display is provided. The system can be any of the devices or embodiments described or otherwise envisioned herein. According to an embodiment, the system comprises a controller device 20, an electronic vehicle-mounted device 10 with display 24, a user device 46, a server 48, and/or a portal 52. Many other configurations and embodiments of the vehicle-mounted display system are possible.

At step 320 of the method, the system receives display input from an advertiser. According to an embodiment, an advertiser is any person, company, business, non-profit, or other entity that intends to display information on display 24 of electronic vehicle-mounted device 10. The advertiser can provide information via portal 52, which can be a mobile application and/or website. According to an embodiment, the portal is available to everyone, and thus everyone will have the ability to push advertisements to display 24. An advertiser may be required to create an account within the mobile application and/or website, such as an email, password, and username. Advertisers may also be required to provide or store payment information with their profile.

According to an embodiment, when a user wants to publish an advertisement, they interact with the portal to provide the information. The portal may provide a series of questions or input fields to obtain mandatory and/or optional information. For example, the portal may comprise a field for the upload of an image or document that will be displayed on the display.

As another example, the advertiser may provide an area that they would like their advertisement(s) to be displayed on the display, such as via a map of the desired location. This area can be as large or as precise as they would like. According to an embodiment, an advertiser could request advertisements on networked vehicle-mounted displays all over the desired location, or they could request ads be placed on a vehicle that is driving down a specific city block. Many geofences and other location-specific options are possible. As yet another example, the advertiser may provide a time of day that they would like their advertisement(s) to be displayed on the display. These options will provide the advertiser with locational and temporal options for their advertisements, among other types of options.

According to an embodiment, the advertiser provides scheduling information for the advertisement(s) to be displayed on the display, such as a date or date range. For example, the advertiser may request that the advertisements be displayed immediately and/or at some future date or date range.

According to an embodiment, the display input also comprises payment information received from the advertiser. After indicating their advertising preferences, the advertiser may be shown a quote or an estimate of the ad placement cost per hour or other timeframe, if that information is available. The advertiser may then be asked for payment of that amount.

According to another embodiment, two or more advertisers bid for placement of their information on the display. Each advertiser can provide a bid comprising an offer for placement, such as a maximum amount per hour or other timeframe, and/or a desired maximum number of advertisement placements.

According to an embodiment, in addition to simple text or image display, the system may allow for the display of moving images or short videos. The advertiser may be given an option to involve interactive visuals on the advertisements. For example, the advertiser can input a business address that they want viewers (customers) to come to. The system could use location services to render an arrow that points in the direction of that address. This arrow will update in real-time while the driver moves by using location services in the controlling device and/or the user device, such as the driver's smartphone. Other real-time interactive visuals can be incorporated as well.

Once the advertisement input is received from the advertiser, it can be transmitted to the server 48, user device 46, and/or controller device 20.

At step 330 of the method, the advertiser input is reviewed and/or approved or denied. Although according to one embodiment every advertiser input may be eligible for display, in other embodiments only reviewed and approved advertisements may be displayed. Review of advertiser input may comprise a review of the advertiser, payment information, the content of the advertisement, the history of the advertiser account, and/or one or more other parameters of the input or advertiser. The review may be manual or automated.

For example, the review may comprise a review of the advertiser's account, and an account with a certain history, approval rating, or other parameter may receive automatic approval of their advertiser input. As another example, all new advertiser accounts may be flagged or queued for manual review. According to an embodiment, the system may be configured or designed to automatically review all content for objectionable content. Objectionable content may be defined based on programming, and may comprise time and location aspects. For example, some advertisements may be suitable after a certain time or in certain places, and unsuitable at other times and places. The system may also be configured or designed to provide every advertiser input to an administrator who authorizes or denies each input.

According to an embodiment, after an order has been made there can be a notification, website, or other screen that allows the advertiser to see the progress of their advertisement. It can display the current status of the ad, such as active or not active. If it is active, there can be a counter for the total amount of ad placement time. There can also be a counter of how many cars it is currently placed on. If it is placed on zero cars, there can be a display of the number of ads ahead of it in queue. Additionally, in the screen there can be the option to change both the location of the ad placements and the desired time slot, as well an option for the advertiser to change a bid price.

At step 340 of the method, user device 46 receives advertiser input. The user device may only receive approved advertiser input, and/or may receive advertiser input that must be reviewed and approved or denied. For example, the user device may be a smartphone of a taxi driver or other driver, which receives the advertiser input from a wireless connection such as a cellular phone network. The user device may be configured with a computer application such as a mobile app that the user installs in order to participate in the system. The application can track the vehicle's location through location services in the user device and/or the controller device. Additionally, the app can track directional movement and the local time. According to an embodiment, when a bid for advertisement space is received, the system may be configured or designed to push advertisements to displays based on an algorithm that maximizes profit and efficiency.

According to an embodiment, the system comprises a mobile application via which multiple steps of the method are completed. For example, the mobile application can comprise a first portion, section, or part that receives display input from an advertiser. The mobile application may also comprise a second portion, section, or part that the user accesses via the user device to review, approve, reject, modify, or otherwise utilize the display input from the advertiser. According to another embodiment, any one or both of the first and second portions, sections, or parts can be a website or other portal through which the advertiser or user interacts to provide or receive information.

According to an embodiment, the user device and computer app may comprise a user interface to display information to the user and/or to receive information from the user. For example, there may be an indicator of connectivity to the controller device 20 and/or the vehicle-mounted display 24, a display of the vehicle-mounted display's power, a display of the current displayed advertisement, a display of a future advertisement, display of the current advertisement pay rate, an option for approving or rejecting an advertisement, and/or an option to accept all advertisements, among many other indicators and information.

Alternatively, at step 340, approved advertiser input is received directly by the vehicle-mounted device, such as through the communications module of the controller device 20.

According to an embodiment, the driver or owner of a vehicle including a vehicle-mounted display, or other entity responsible for the vehicle-mounted display, is compensated for the display of the advertisement. This may be a certain predetermined percentage of the amount received from the advertisements displayed on the device, a fixed fee for time or per advertisement, or according to any other payment scheme. Payment may occur at any point of the method, including a lump sum at weekly, monthly, yearly, or any other interval.

At step 350 of the method, approved advertiser input is pushed to the controller device 20 and/or the vehicle-mounted display 24. The approved advertiser input may be pushed only when it is to be displayed, or may be pushed along with scheduling parameters. The push may include any information necessary for display, including but not limited to graphical information, text information, scheduling information, temporal and/or geographical limitations or aspects, real-time parameters and aspects, and other information.

According to an embodiment, the user device automatically pushes received advertiser input to the controller device 20 and/or the vehicle-mounted display 24 when advertiser input is received. For example, the system may comprise a scheduling module that determines scheduling and display for the user device. According to another embodiment, the user device, controller device, and/or the computer app is configured with a scheduling module that automatically schedules the display of received advertiser input to the display. Alternatively, the system may require a manual push from the user, such as a swipe, click, shake, or other affirmative action, to push the content to the controller device and/or display.

According to an embodiment, the user reviews the advertiser input and determines whether it is approved or denied. The review may be based on any parameter of the advertiser input, including but not limited to content, geographic and temporal parameters, the identity of the advertiser, the history of the advertiser account, and any other parameter. For example, review may be based solely on a swipe or click to identify a submission as approved or denied. That information can then be relayed to the advertiser.

At step 360 of the method, pushed advertiser input is displayed on the vehicle-mounted display. The pushed advertiser input may be displayed on one or multiple sides of the display, and may be static or dynamic. The pushed advertiser input may be displayed immediately, or may be displayed according to a schedule or other display-restricting or display-approving parameter.

At step 370 of the method, the displayed advertiser input is modified. The modification may be removal of the displayed advertiser input once the approved display time has ended. The modification may be pursuant to one or more display parameters, including but not limited to a geographic parameter or a temporal parameter. For example, the display may change in form if a geofence or other defined location or geographic boundary is reached. As just one example, the display may be dynamic such that an arrow is always pointing toward business 123 Book Binding as the vehicle drives around a city, which would require movement of the arrow's direction as the vehicle changes direction. Accordingly, the arrow or other indicator may be movable about the display. Many other dynamic advertisements are possible, including but not limited to advertisements that are modified by location, time, and other parameters.

According to another embodiment, the display changes from one pushed advertiser input to a second advertiser input based on a geographic parameter or a temporal parameter. For example, the display may change to a different advertisement if the vehicle is in a certain location such as a village or on a specific street. As just one example, the system may be configured such that the ABC Car Wash advertisement is displayed whenever the vehicle is within two miles of an ABC Car Wash establishment, and may switch back to a previous advertisement or a subsequent advertisement when the vehicle is further than two miles from an ABC Car Wash establishment.

Modification of advertiser input may require sensor input from one or more of the motion sensor 36, an optical sensor 38, and/or the location-aware module 34 (such as GPS). The one or more sensors may provide sensor information to the controller device 20 and/or the display 24, which can continuously or periodically analyse the sensor information to determine whether a modification is necessary.

For example, an approved advertiser input may comprise an instruction or parameter such that the advertisement is only displayed when the vehicle is standing still, such as at a light or a stop, and when the vehicle is on Main Street. Accordingly, the system must know when the vehicle is moving and/or not moving, and when the vehicle is on Main Street. Each or all of the motion sensor 36, an optical sensor 38, and/or the GPS 34 may facilitate the display of this advertisement. For example, the information received by the GPS receiver can be utilized to determine whether the vehicle is in motion, and whether the vehicle is on Main Street. Alternatively, data from motion sensor 36 may be utilized to determine whether the vehicle is in motion. Additionally, data from optical sensor 38 may be utilized to determine whether the vehicle is in motion, and whether the vehicle is on Main Street. For example, a camera may take a series of images that can be analysed by the system for differences indicative of motion. These same images can be analysed by the system to look for indicators of location, through a mechanism such as comparing images to known images of Main Street, among many other methods.

The controller 22 or other component of the system receives the GPS information and/or other sensor information and determines whether to display or not display the advertisement. This can comprise, for example, a comparison of location and/or movement data to programmed parameter ranges or thresholds.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

1. A method for displaying information on a vehicle-mounted device, the method comprising the steps of:
receiving display input from an advertiser, the display input comprising information to be displayed on the vehicle-mounted device and one or more display parameters;
sending the received display input to a user device of the vehicle-mounted device display system;
approving the received display input for display on the vehicle-mounted device;
sending the approved display input from the user device to the vehicle-mounted device for display; and
displaying the approved display input on the vehicle-mounted device.

2. The method of claim 1, wherein the display input comprises one or more parameters for the display of the display input on the vehicle-mounted device.

3. The method of claim 2, further comprising the step of modifying, based on at least one of the one or more parameters, the display of the approved display input on the vehicle-mounted device.

4. The method of claim 2, wherein the one or more parameters comprises at least one of a geographical parameter and a scheduling parameter.

5. The method of claim 1, wherein the display input further comprises a bid for display of the display input on the vehicle-mounted device, and wherein the method further comprises the step of determining a winning bid for display of the display input on the vehicle-mounted device, wherein the received display input associated with the winning bid is sent to the user device.

6. The method of claim 1, wherein the user device is a smartphone, wearable computing device, or other computing device.

7. A method for displaying information on a vehicle-mounted device, the method comprising the steps of:
receiving display input from a plurality of advertisers, each received display input comprising information to be displayed on the vehicle-mounted device and one or more parameters for the display of the display input on the vehicle-mounted device, and further comprising a bid for display of the display input on the vehicle-mounted device;
determining, by the vehicle-mounted device display system, a winning bid among the plurality of received bids;
sending the received display input associated with the winning bid to a user device of the vehicle-mounted device display system;
approving the received display input for display on the vehicle-mounted device;
sending the approved display input from the user device to the vehicle-mounted device for display;
displaying the approved display input on the vehicle-mounted device; and
modifying, based on at least one of the one or more parameters, the display of the approved display input on the vehicle-mounted device.

8. The method of claim 7, wherein the one or more parameters comprises at least one of a geographical parameter and a scheduling parameter.

9. The method of claim 7, further comprising the step of:
determining, by the vehicle-mounted device display system, a location of the vehicle-mounted device;
wherein the display of the approved display input on the vehicle-mounted device is modified based on the determined location.

10. The method of claim 7, wherein said one or more parameters comprises a geofence.

11. The method of claim 7, wherein a user of the user device approves the received display input for display on the vehicle-mounted device.

12. The method of claim 7, wherein the user device is a smartphone, wearable computing device, or other computing device.

13. A system for displaying information on a vehicle-mounted device, the system comprising:
a vehicle-mounted device comprising a display configured to display approved advertiser display input;
an advertiser portal configured to receive display input from an advertiser, the display input comprising information to be displayed on the vehicle-mounted device and one or more display parameters;
a display controller configured to receive, from the advertiser portal, the advertiser display input; and
a user device configured to receive the advertiser display input from the display controller, and further configured to send approved advertiser display input to the vehicle-mounted device.

14. The system of claim 13, wherein the advertiser portal is a website hosted on a server.

15. The system of claim 13, wherein the display input further comprises one or more parameters for the display of the display input on the vehicle-mounted device.

16. The system of claim 15, wherein the user device is further configured to modify, based on at least one of the one or more parameters, the display of the approved advertiser display input on the vehicle-mounted device.

17. The system of claim 15, wherein the one or more parameters comprises at least one of a geographical parameter and a scheduling parameter.

18. The system of claim 13, wherein the display input further comprises a bid for display of the display input on the vehicle-mounted device; and wherein the display controller is further configured to determine a winning bid for display of the display input on the vehicle-mounted device.

19. The system of claim 13, wherein the user device is configured to: (i) determine a location of the vehicle-mounted device; and (ii) modify, based on the determined location, the display of the approved advertiser display input on the vehicle-mounted device.

20. The system of claim 13, wherein the user device is a smartphone, wearable computing device, or other computing device.
